(19) United States
(12) Patent Application Publication
(10) Pub. No.: US 2020/0254977 A1
(43) Pub. Date: Aug. 13, 2020

(54) A WINDSCREEN WIPER DEVICE

(71) Applicant: FEDERAL-MOGUL S.A., Aubange (BE)

(72) Inventor: Thimotey Marchand, Herserange (FR)

(21) Appl. No.: 16/639,656

(22) PCT Filed: Aug. 15, 2017
(86) PCT No.: PCT/EP2017/070647

§ 371 Date: Feb. 17, 2020

(51) Int. Cl. B60S 1/40

(52) U.S. Cl. CPC B60S 1/4064; B60S 1/4087

(57) ABSTRACT

A windscreen wiper device is provided comprising a carrier element, and a wiper blade. The device comprises a connecting device pivotally and detachably connected to a joint part. The joint part comprises at least one resilient tongue to engage a hole provided in the oscillating arm. The resilient tongue is hingeable and comprises a first step to abut an edge of the hole of an oscillating arm of a first type and a second step to abut an edge of the hole of an oscillating arm of a second type. The joint part comprises at least one stepped profile to block longitudinal movement of the oscillating arm of the first type in a direction towards the free end of the joint part and to block longitudinal movement of the oscillating arm of the second type in a direction towards the free end of the joint part.

### BACKGROUND OF THE INVENTION

A windscreen wiper device is generally known from European patent publication no. 1 403 156 of the same Applicant. This prior art windscreen wiper device is designed as a “yokeless” wiper device or “flat blade”, wherein no use is made of several yokes pivotally connected to each other, but wherein the wiper blade is biased by the carrier element, as a result of which it exhibits a specific curvature. In this prior art windscreen wiper device, the joint part comprises at least one resilient tongue engaging in a correspondingly shaped hole provided in the oscillating arm, wherein the resilient tongue is rotatable along an hinge axis between an outward position retaining the wiper blade onto the oscillating arm and an inward position releasing the wiper blade from the oscillating arm. In order to connect the wiper blade onto the oscillating arm, the resilient tongue is initially pushed in against a spring force—as if it were a push button—and then allowed to spring back into the hole provided in the oscillating arm, thus snapping, that is clipping the resilient tongue into the hole. By subsequently pushing in again the resilient tongue against the spring force, the wiper blade may be released from the oscillating arm. In practice, this interconnection between said joint part and said oscillating arm is called a bayonet connection.

### SUMMARY OF THE INVENTION

The object of the invention is to provide an improved windscreen wiper device at minimum costs, without using complex machinery and additional tools, while the connecting device and the oscillating arm can be interconnected in a reliable and secure manner, using less parts.

The wiper blade includes at least one longitudinal groove, in which groove a longitudinal strip of the carrier element is disposed. The windscreen wiper device comprises a connecting device for an oscillating arm and the oscillating arm can be pivotally connected to the connecting device about a pivot axis near one end, with the interposition of a joint part. The joint part comprises at least one resilient tongue arranged to engage into a correspondingly shaped hole provided in a base of a U-shaped cross-section of the oscillating arm. The resilient tongue is hingeable between an inward position, wherein the wiper blade can be released from said oscillating arm, and an outward position, wherein the wiper blade can be retained on said oscillating arm.

In use, the oscillating arm is connected to a mounting head mounted on a drive shaft. The oscillating arm at one end thereof is pivotally connected to the mounting head by means of a pivot pin and at another end thereof is connected to the wiper blade placed in abutment with said windscreen to be wiped. In use, the shaft rotates alternately in a clockwise and in a counter-clockwise sense carrying the mounting head into rotation also, which in turn draws the oscillating arm into rotation and by means of the connecting device moves the wiper blade. The oscillating arm can thus oscillate to-and-from between a first reversal position and a second reversal position. In the first reversal position, the oscillating arm extends parallel to a windscreen to be wiped and is located near a lower edge of the windscreen to be wiped. Also, in the second reversal position, the oscillating arm extends parallel to a windscreen to be wiped and is located in a central region or near a side edge of the windscreen to be wiped.

It is noted that the present invention is not restricted to automobiles, but also refers to rail coaches and other (fast) vehicles.

In order to accomplish the stated objective, a windscreen wiper device of the type referred to previously is characterized according to the invention in that the resilient tongue comprises a first step and a second step. The first step is arranged to abut an edge of the hole of an oscillating arm of a first type facing towards a free end thereof. The second step is arranged to abut an edge of the hole of an oscillating arm of a second type facing towards a free end thereof. The oscillating arm of the first type and the oscillating arm of the second type mutually differ in a distance between legs of the U-shaped cross-section of the oscillating arms.

The joint part comprises, near a free end thereof facing towards the free end of a respective oscillating arm of the first type or the second type, at least one stepped profile. The at least one stepped profile comprises a first step arranged to block a longitudinal movement of the oscillating arm of the first type in a direction towards the free end of the joint part and a second step arranged to block a longitudinal movement of the oscillating arm of the second type in a direction towards the free end of the joint part.

Preferably, an upper surface of the first step of the resilient tongue and the stepped profile, respectively, is located closer to the wiper blade (and in use thus to a windscreen to be wiped) than an upper surface of the second step of the resilient tongue and the stepped profile, respectively. On the one hand, the first and second steps of the resilient tongue act as stop surfaces and block the wiper blade relative to the respective oscillating arms of the first and second type in a direction away from the free end of the joint part (i.e. towards the mounting head). On the other hand, the first and second steps of the stepped profile also act as stop surfaces and block the wiper blade relative to said respective oscillating arms of the first and second type in a direction towards the free end of the joint part (i.e. away from the mounting head). Preferably, the joint part comprises two stepped profiles on opposite lateral sides thereof.

Preferably, the joint part is detachably connected to the connecting device particularly through a snapping/clipping operation. In particular, the snapping operation is realized by pivotally engaging protrusions of the connecting device at the location of the pivot axis into recesses provided in the joint part. More in particular, the joint part has an at least substantially U-shaped cross-section at the location of its attachment to the connecting device. Each leg of the U-shaped cross-section is provided with a recess provided coaxially with the pivot axis. Further, the protrusions that function as bearing surfaces, are spaced far apart, so that the forces exerted thereon will be relatively low.

The joint part is arranged to be connected to the connecting device for different U-shaped cross-sections of the oscillating arm. The joint part is subsequently connected to the connecting device by the pivotally engaging protrusions of the connecting device, at the location of the pivot axis, in the recesses provided in the joint part. The oscillating arm can be subsequently connected to the joint part.

An essence of the present invention is that the connecting device and the joint part each are a universal connection part for each type of U-shaped cross-section of the oscillating arm. A same type of the joint part to be connected to a same type of the connecting device may be used for each different type of U-shaped cross-section of the oscillating arm. The advantage achieved by the invention is that a unit consisting of the wiper blade, the connecting device and the joint part connected to the connecting device can be manufactured for each and every type of U-shaped cross-section of the oscillating arm. Thus, a universal connection between the wiper blade and the oscillating arm is obtained, so that car drivers are given the possibility to buy also non-original cheap wiper blades fitting the original oscillating arms on their cars. As indicated above, the U-shaped cross-sections of the oscillating arms mutually differ as far as the distance between the legs of the U-shaped cross-section of the respective oscillating arm is concerned. In particular, the distance in the oscillating arm of the first type is 22 mm, while the distance in the oscillating arm of the second type is 19 mm.

The present invention thus provides a universal connecting unit (consisting of the connecting device and the joint part) that is firmly attached to the oscillating arm.

Preferably, each leg of the U-shaped cross-section of the oscillating arms of the first type and the second type comprises clamping members engaging around longitudinal sides of the joint part that face away from each other. Hence, a locking of the wiper blade in transverse direction (in use perpendicular to a windscreen to be wiped) is ensured. The clamping members are preferably formed by bended edges of the legs of the U-shaped cross-section and are in one piece therewith. Particularly, the first step of the stepped profile is arranged to abut against the inwardly bent edges of legs of the U-shaped cross-section of the oscillating arm of the first type. More in particular, the second step of the stepped profile is arranged to abut against legs of the U-shaped cross-section of the oscillating arm of the second type. The joint part is preferably made in one piece of plastic.

In a preferred embodiment of a windscreen wiper device in accordance with the invention, the joint part comprises at least one laterally outwardly extending resilient protrusion arranged to engage a leg of the U-shaped cross-section of the oscillating arm of the first type. Particularly, the joint part comprises two laterally outwardly extending resilient protrusions on opposite lateral sides thereof, thereby minimizing the relative motion, commonly referred to as play, between the joint part and oscillating arm of the first type.

In a further preferred embodiment of a windscreen wiper device according to the invention, the joint part is detachably connected to the connecting device by engaging protrusions of the connecting device, at the location of the pivot axis, in recesses provided in the joint part. The protrusions of the connecting device are provided with co-axial through holes. An upper surface of the joint part comprises a recess arranged to accommodate a L-shaped shoulder provided near the free end of an oscillating arm of a third type and the co-axial through holes are arranged to receive a transverse pivot pin provided near the free end of the oscillating arm of the third type. A side of the joint part is arranged to abut a leg of the L-shaped shoulder disposed at an end thereof and facing a windscreen to be wiped. Preferably, the joint part has an at least substantially U-shaped cross-section at the location of its connection to the connection device. The joint part in each leg of the U-shaped cross-section is provided with the recess provided co-axially with the pivot axis. The co-axial recesses of the legs of the U-shaped cross-section and the co-axial through holes of the protrusions of the connecting device are arranged to receive the pivot pin of the oscillating arm of the third type.

In a further preferred embodiment of a windscreen wiper device in accordance with the invention, the joint part is provided with a free end having a recess arranged to accommodate the free end of an oscillating arm of a fourth or fifth type. The joint part comprises at least one protrusion extending laterally from a longitudinal side of the joint part, the protrusion being arranged to hook behind a correspondingly shaped protrusion on the oscillating arm of the fourth or fifth type for blocking a longitudinal movement of the wiper blade with respect to the oscillating arm of the fourth or fifth type. Particularly, the joint part has an at least substantially U-shaped cross-section at the location of its connection to the connection device. A base of the U-shaped cross-section of the joint part comprises the recess arranged to accommodate the free end of the oscillating arm of the fourth or fifth type. More in particular, the free end of the joint part is resilient and can pivot about a hinge axis between a first position for mounting or dismounting the free end of the oscillating arm of the fourth or fifth type into or from the recess in the base of the U-shaped cross-section of the joint part, and a second position for connecting the free end of the oscillating arm of the fourth or fifth type to the joint part.

In another preferred embodiment of a wiper device in accordance with the invention, the protrusions extending laterally from the longitudinal side of the joint part are arranged on a resilient part of the longitudinal side. Thereby, the resilient part is arranged to hinge inwardly and outwardly in a direction laterally from the longitudinal side about a hinge axis. The additionally added resilient part on the joint part enables an easier and more reliable installation of the joint part in oscillating arms of the first and second type, as the resilient part is allowed to hinge when engaged with an interior surface of the U-shaped cross-section of the oscillating arms of the first and second type.

In a further preferred embodiment of a wiper device according to the invention, a protrusion extending laterally from an upper surface of the joint part near an extremity of the joint part facing away from the free end of a respective oscillating arm is provided. The protrusion is arranged to cooperate with a substantially inwardly extending tongue-shaped protrusion arranged at hole in the base of the substantially U-shaped cross-section of an oscillating arm of the fifth type.

In a further preferred embodiment of a windscreen wiper device according to the invention, a cover is detachably connected to the joint part, preferably through a snapping/clipping operation. Preferably, the cover is detachably connected to the joint part by engaging protrusions of the connecting device at the location of the pivot axis in recesses provided in the cover.

In a further preferred embodiment of a windscreen wiper device in accordance with the invention, an upper surface of the cover comprises a recess arranged to accommodate a rod-shaped oscillating arm of a sixth type. Preferably, the cover has an at least substantially U-shaped cross-section at the location of its connection to the joint part. The recess is provided in a base of the U-shaped cross-section.

In a further preferred embodiment of a windscreen wiper device in accordance with the invention, the cover is arranged with a recess at an upper surface of a base of the at least substantially U-shaped cross-section. The recess is arranged to cooperate with the protrusion extending laterally from the an upper surface of said joint part near the extremity of the joint part facing away from the free end of the oscillating arm. Particularly, the recess arranged at an upper surface of a base of the at least substantially U-shaped cross-section of the cover is arranged to engage with the protrusion extending laterally from the an upper surface of the joint part near the extremity of the joint part facing away from the free end of the oscillating arm.

In a further preferred embodiment of a windscreen wiper device according to the invention. the cover comprises two spaced-apart guiding protrusions extending upwardly from an upper surface of the cover. The guiding protrusions are adapted to receive the oscillating arm of the sixth type between them. Particularly, the cover is provided with a protrusion in use extending in upward direction away from a windscreen to be wiped. The upwardly extending protrusion is adapted to engage in a correspondingly shaped hole provided in the oscillating arm of the sixth type for retaining the wiper blade onto the oscillating arm of the sixth type.

In a further preferred embodiment of a windscreen wiper device according to the invention, the cover has an at least substantially U-shaped cross section at the location of its connection to the joint part. The cover is provided with through holes in each leg of said U-shaped cross-section. The through holes are co-axially arranged with the pivot axis for receiving a transverse pivot pin provided near the free end of the oscillating arm of the seventh type. An upper surface of the cover is arranged to accommodate the L-shaped shoulder provided near the free end of said oscillating arm of the seventh type. Preferably, at least one outwardly extending protrusion is arranged on at least one side of a longitudinal side of the cover. Said outwardly extending protrusion is arranged to abut a leg of the L-shaped shoulder arranged near the free end of the oscillating arm of the seventh type. Hereby, a reliable connection is obtained between the wiper blade and the oscillating arm of the seventh type.

The present invention thus provides a universal connecting unit (consisting of the connecting device, the joint part, and the cover) that can firmly be attached to the oscillating arms of the first, second, third, fourth, fifth, sixth and seventh type. Hence, the invention works to the benefit of car owners as they are not required to buy the more expensive original replacement parts in case the wind screen wipers needs replacing and on the other hand do not need to do the research to determine which type of wiper blade fits their vehicle, as the universal connection of the according to the invention fits six different types of oscillating arms.

The present invention is also directed to a method for manufacturing a windscreen wiper device of the flat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, wherein the oscillating arm can be pivotally connected to the connecting device about a pivot axis near one end, with the interposition of a joint part, wherein the joint part comprises at least one resilient tongue arranged to engage into a correspondingly shaped hole provided in a base of a U-shaped cross-section of said oscillating arm, wherein the resilient tongue is hingeable between an inward position, wherein the wiper blade can be released from the oscillating arm, and an outward position, wherein the wiper blade can be retained on the oscillating arm, characterized in that the resilient tongue is provided with a first step and a second step, wherein the first step is arranged to abut an edge of the hole of an oscillating arm of a first type facing towards a free end thereof, wherein the second step is arranged to abut an edge of said hole of an oscillating arm of a second type facing towards a free end thereof, and wherein the oscillating arm of the first type and the oscillating arm of the second type mutually differ in a distance between legs of the U-shaped cross-section of the oscillating arms, and wherein the joint part is provided near a free end thereof facing towards said free end of a respective oscillating arm of the first type or the second type with at least one stepped profile having a first step arranged to block a longitudinal movement of the oscillating arm of the first type in a direction towards the free end of said joint part, and having a second step arranged to block a longitudinal movement of the oscillating arm of the second type in a direction towards free end of the joint part.

### BRIEF DESCRIPTION OF THE DRAWINGS

The invention will now be explained in detail with reference to figures illustrated in the accompanying drawings.

FIG. 1 shows several schematic and perspective views of part of a windscreen wiper device in a preferred embodiment, comprising a connecting device, a joint part and an oscillating arm of the first type in different stages of the assembly process.

FIG. 2 shows several schematic and perspective views of part of a windscreen wiper device in a preferred embodiment, comprising a connecting device, a joint part and an oscillating arm of the second type in different stages of the assembly process.

FIG. 3 shows several perspective views of part of a connecting device, a joint part and an oscillating arm of the third type in different stages of the assembly process.

FIG. 4 shows several schematic and perspective views of part of a windscreen wiper device in a preferred embodiment, comprising a connecting device, a joint part and an oscillating arm of the fourth type in different stages of the assembly process.

FIG. 5 shows several perspective views of part of a windscreen wiper device in a preferred embodiment, comprising a connecting device, a joint part and an oscillating arm of the fifth type in different stages of the assembly process.

FIG. 6 shows several perspective views of part of a windscreen wiper device in a preferred embodiment, comprising a connecting device, a joint part and a cover in different stages of the assembly process.

FIG. 7 shows several perspective views of part of a windscreen wiper device in a preferred embodiment, comprising a connecting device, a joint part with an attached cover and an oscillating arm of the sixth type in different stages of the assembly process.

FIG. 8 shows several perspective views of part of a windscreen wiper device in a preferred embodiment, comprising a connecting device, a joint part with an attached cover and an oscillating arm of the seventh type in different stages of the assembly process.

### DETAILED DESCRIPTION OF THE PREFERRED EMBODIMENTS

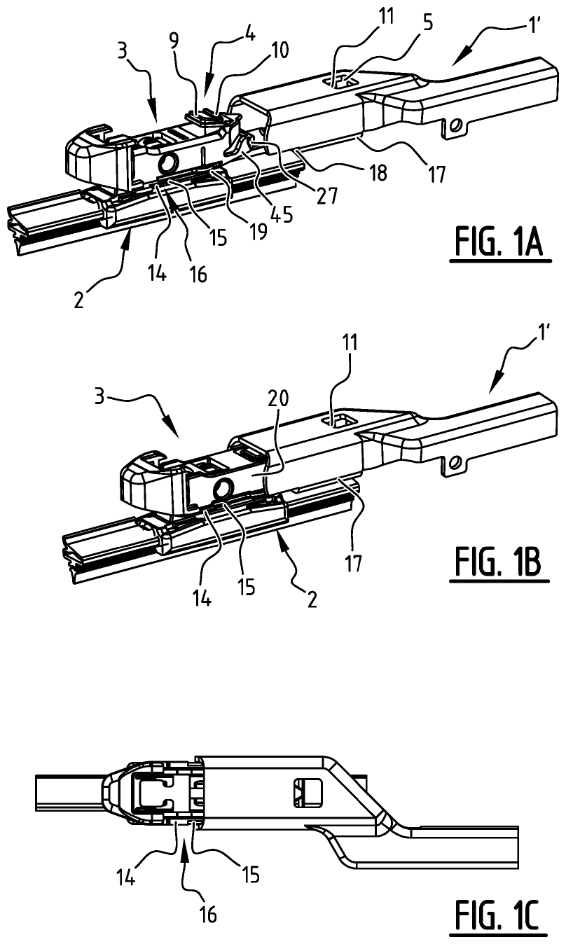

FIG. 1 shows several schematic and perspective views of part of a windscreen wiper device in a preferred embodiment, comprising a connecting device 2, a joint part 3 and an oscillating arm 1′ of the first type in different stages of the assembly process. Such a windscreen wiper device of the flat blade type is typically built up of an elastomeric (rubber) wiper blade comprising a central longitudinal groove, wherein a longitudinal strip made of spring band steel is fitted in the longitudinal groove. The strip forms a flexible carrier element for the rubber wiper blade, as it were, which is thus biased in a curved position (the curvature in operative position being that of a windscreen to be wiped). Usually an end of the strip and/or an end of the wiper blade is connected on either side of the windscreen wiper device to respective connecting pieces or “end caps”. The connecting pieces may be formed as separate constructional elements, which may be form-locked as well as force-locked to both ends of the strip and/or ends of the wiper blade. In the alternative, the connecting pieces may be in one piece with the strip made of spring band steel. The windscreen wiper device is furthermore built up of a connecting device 2 for connecting the oscillating wiper arm 1′ of the first type thereto, with the interposition of a joint part 3. The oscillating wiper arm 1′ of the first type is pivotally connected to the connecting device 2 about a pivot axis near one end.

The joint part 3 comprises a resilient tongue 4 extending outwardly, while the oscillating arm 1′ of the first type has said U-shaped cross-section at the location of its connection to the joint part 3, so that the tongue 4 engages in an correspondingly shaped hole 5 provided in a base of the U-shaped cross-section. The connecting device 2 with the wiper blade is mounted onto the oscillating arm 1′ of the first type as follows. The joint part 3 being already clipped onto the connecting device 2, so that the joint part 3 can be easily slid on a free end of the oscillating arm 1′ of the first type. During this sliding movement the resilient tongue 4 is initially pushed in against a spring force and then allowed to spring back into said hole 5, thus snapping, that is clipping the resilient tongue 4 into the hole 5. This is a so-called bayonet-connection. By subsequently pushing in again said resilient tongue 4 against the spring force (as if it were a push button), the connecting device 2 and the joint part 3 together with the wiper blade may be released from the oscillating arm 1′ of the first type. Dismounting the connecting device 2 with the wiper blade from the oscillating arm 1′ is thus realized by sliding the connecting device 2 and the joint part 3 together with the wiper blade in a direction away from the oscillating arm 1′ of the first type.

Although not shown in FIG. 1, but fully understood by a skilled person, the oscillating arm 1′ of the first type is connected to a mounting head fixed for rotation to a shaft driven by a small motor. In use, the shaft rotates alternately in a clockwise and in a counter-clockwise sense carrying the mounting head into rotation also, which in turn draws said oscillating arm 1′ of the first type into rotation and by means of the connecting device 2 moves the wiper blade.

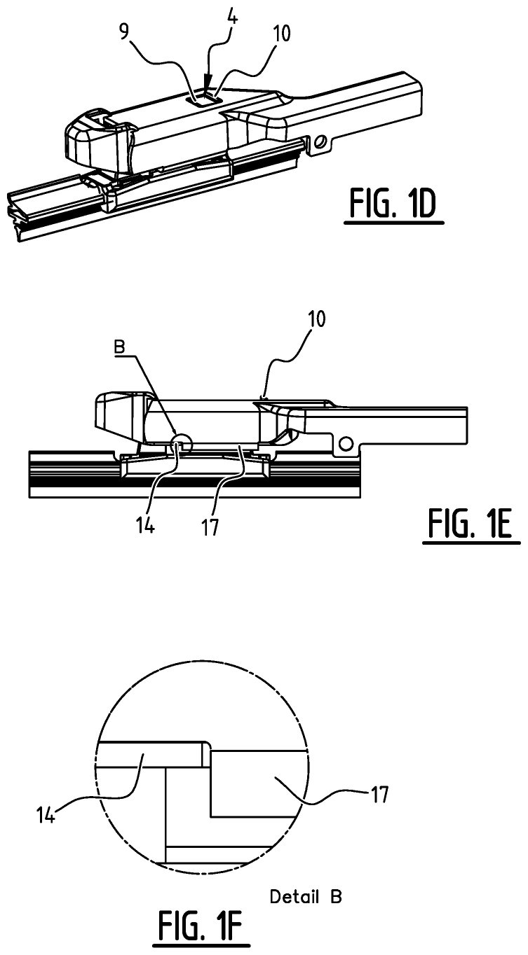

FIG. 2 shows several schematic and perspective views of part of a wind screen wiper device in a preferred embodiment, comprising a connecting device 2, a joint part 3 and an oscillating arm of the second type 1″ in different stages of the assembly process. The oscillating arm of the first type 1′ and the oscillating arms of the second type 1″ are similar in shape but are mutually differing in a distance between legs of an U-shaped cross-section of said oscillating arms 1′,1″. The distance in the oscillating arm 1′ of the first type is 22 mm, while the distance in the oscillating arm 1″ of the second type is 19 mm.

As depicted in FIGS. 1 and 2, the resilient tongue 4 of the joint part 3 comprises a first step 9 and a second step 10 as if it were a staircase. The first step 9 is arranged to abut an edge 11 of the hole 5 of the oscillating arm 1′ of a first type facing towards a free end thereof. The second step 10 is arranged to abut also the edge 11 of the hole 5 of the oscillating arm 1″ of a second type. Sides of the steps 9,10 are indicated with reference numerals 12,13, respectively, which abut the edge 11 of the hole 5 in case an oscillating arm 1′ of the first type or an oscillating arm 1″ of the second type is used.

The legs of the U-shaped cross sections of the respective oscillating arms 1′, 1″ comprise clamping members 17 engaging around the longitudinal sides 20 of the joint part 3, thereby locking the joint part 3 and thus the wiper blade in a transverse direction.

As again depicted in FIGS. 1 and 2, a stepped profile 16 is arranged near a free end of the joint part 3, facing the free end of an oscillating arm of the first or second type 1′,1″, having a first step 14 arranged for blocking a longitudinal movement of an oscillating arm of the first type 1′ and having a second step 15 arranged for blocking a longitudinal movement of an oscillating arm of the second type 1″. In the assembled position, an edge of the stepped profile 16 engages with an edge 18 of the clamping members 17, thereby blocking a longitudinal movement of an oscillating arm 1′,1″.

Furthermore, the joint part 3 comprises a laterally outwardly extending protrusion 19 at the longitudinal side 20 which is arranged to engage with a leg of the U-shaped cross-section of an oscillating arm of the first type 1′ and more specifically is arranged to bent laterally inwardly when engaged with a leg of the U-shaped cross section of an oscillating arm of the second type 1″.

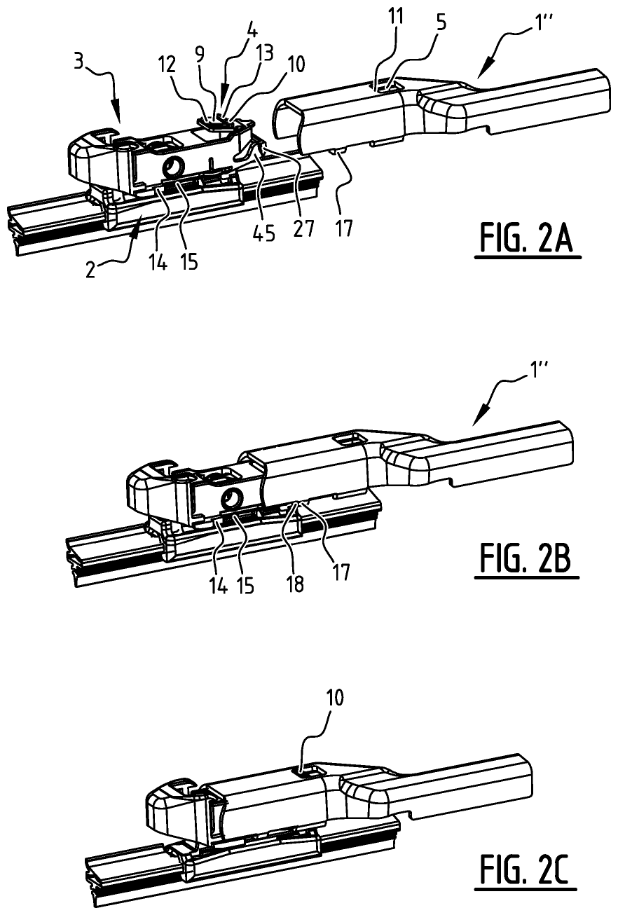

FIG. 3 shows several perspective views of part of a connecting device 2, a joint part 3 and an oscillating arm of the third type 1′″ in different stages of the assembly process. The joint part 3 is detachably connected to the connecting device 2 by engaging protrusions. These protrusions are provided with co-axial through holes 21, arranged for receiving a transverse pivot pin provided 22 near a free end of an oscillating arm of the third type 1′″. A side 20 of the joint part 3 arranged to abut a leg 24 of the L-shaped shoulder 23. In the assembled position, as is shown in FIG. 3c, a lower surface of the L-shaped shoulder abuts the first step 9 arranged on the resilient tongue 4.

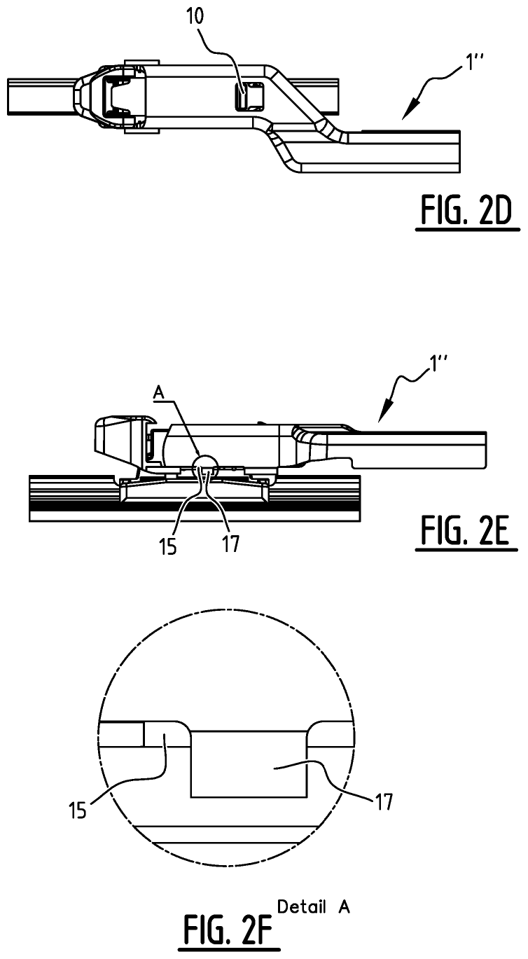

FIG. 4 shows several schematic and perspective views of part of a wind screen wiper device in a preferred embodiment, comprising a connecting device 2, a joint part 3 and an oscillating arm of the fourth type 1″″ in different stages of the assembly process. The joint part 3 is provided with a free end having a recess 25 arranged to accommodate free end 26 of an oscillating arm of the fourth type 1″″. The joint part 3 comprising a protrusion 27 extending laterally from a longitudinal side 20, which is arranged to hook behind a correspondingly shaped protrusion 28 on the leg of the U-shaped cross-section of an oscillating arm of the fourth type 1″″. The free end 29 of the joint part 3 is resilient and can pivot about a hinge axis between a first position for mounting or dismounting the free end 26 of the oscillating arm of the fourth type 1″″ and a second position for locking the free end 26 to the joint part 3. More particularly, the free end 26 of the oscillating arm of the fourth type 1″″ is locked in the recess 25 formed by the protrusions 30 at the free end 29 of the joint part 3.

In the preferred embodiment shown, the protrusions 27 extending laterally from the longitudinal side 20 of the joint part 3 are arranged on a resilient part 45 of the longitudinal side 20. The protrusions 27 are arranged to hook behind a correspondingly shaped protrusion 28 on the leg of the U-shaped cross-section of an oscillating arm of the fourth type 1″″. The resilient part 45 is arranged to hinge inwardly and outwardly in a direction laterally from the longitudinal side about a hinge axis, thereby allowing bending of the resilient part 45 if the protrusions 27 engage with an interior surface of the U-shaped cross-section of an oscillating arm of the first or second type 1′, 1″ on installation of oscillating arms.

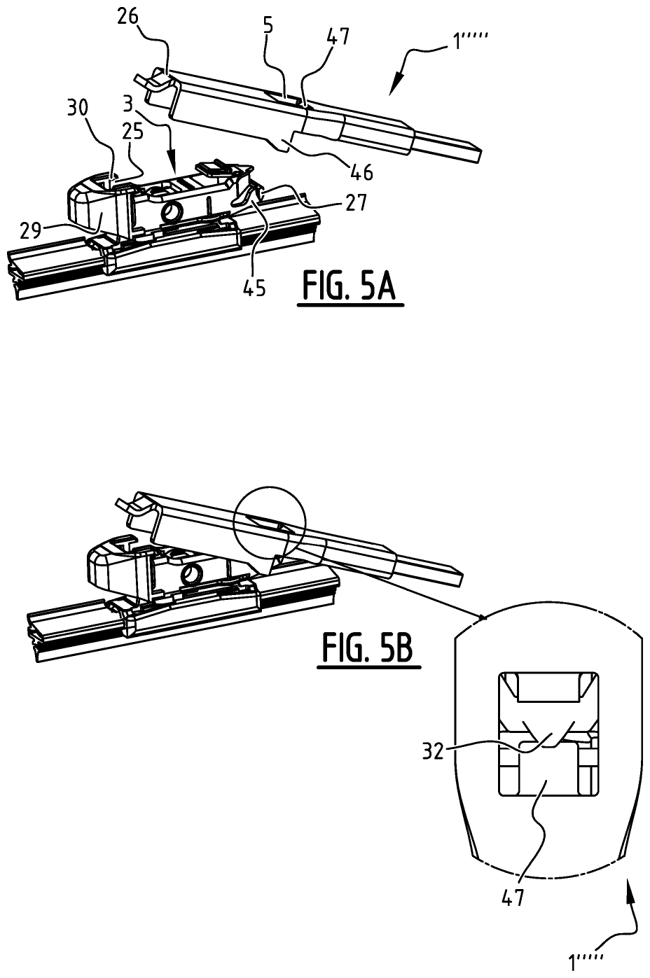

FIG. 5 shows several perspective views of part of a wind screen wiper device in a preferred embodiment, comprising a connecting device, a joint part and an oscillating arm of the fifth type in different stages of the assembly process. The oscillating arm is provided with a protrusion 46 being substantially right-angled with the oscillating arm at a first side and a free end 26 of the oscillating arm of the fifth type. The right-angled protrusion 46 is arranged to cooperate with the protrusions 27 extending laterally from the longitudinal side 20 of the joint part 3. A hole 5 is provided in the base of the substantially U-shaped cross-section of the oscillating arm of the fifth type, wherein a substantially inwardly extending tongue-shaped protrusion 47 is provided. The tongue-shaped protrusion is arranged to engage a protrusion 32, which is arranged on the joint part 3 on a side opposite to the free end 29 of the joint part 3.

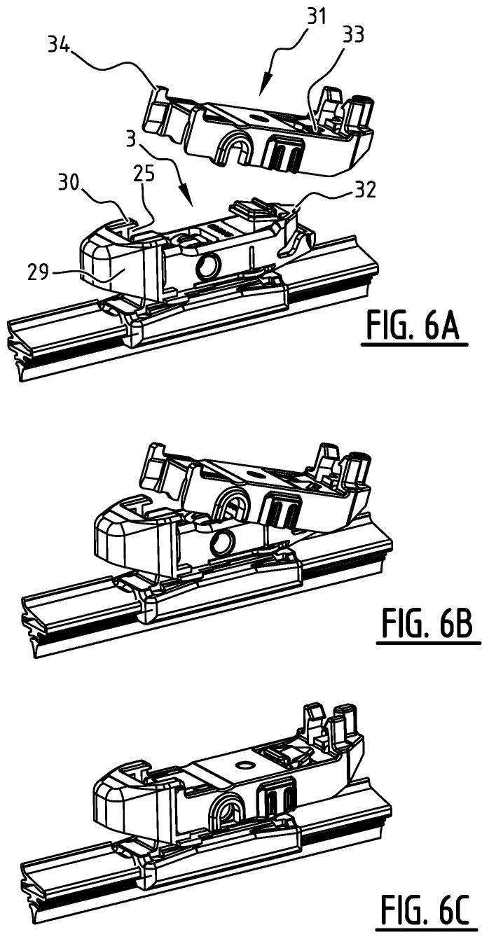

FIG. 6 shows several schematic and perspective views of part of a windscreen wiper device in a preferred embodiment, comprising a connecting device 2, a joint part 3 and a cover 31 in different stages of the assembly process. The U-shaped cover 31 is detachably connected to the joint part 3, thereby substantially covering the joint part 3. Protrusion 32 is arranged on the joint part 3 on a side opposite to the free end 29 of the joint part 3 to engage in a corresponding recess 33 arranged on the cover 31 and in conjunction with a upwardly extending protrusion 34 on the cover, arranged to engage the recess 25 of the free end 29 of the joint part 3 connects the cover 31 to said joint part 3. The free end 29 of the joint part 3 is resilient and can pivot about a hinge axis between a first position for mounting or dismounting the cover 31 and a second position for locking said cover 31.

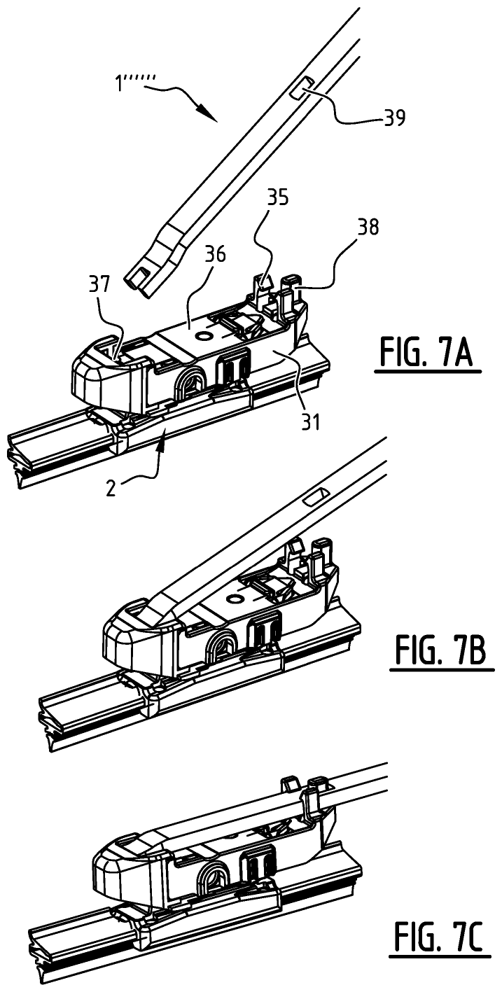

FIG. 7 shows several schematic and perspective views of part of a windscreen wiper device in a preferred embodiment, comprising a connecting device 2, a joint part 3 with an attached cover 31 and an oscillating arm of the sixth type 1″″″ in different stages of the assembly process. The cover 31 comprises a recess 37 arranged to accommodate the rod-shaped free end of an oscillating arm of the sixth type 1″″″, two spaced apart guiding protrusions 35 extending upwardly from an upper surface 36 of the cover for receiving the oscillating arm of the sixth type 1″″″ in between them. The cover 31 if further provided with a protrusion 38 extending in an upward direction away from the windscreen to be wiped, the upward extending protrusion 38 is arranged to engage in a correspondingly shaped hole 39 provided in the oscillating arm of the sixth type 1″″″.

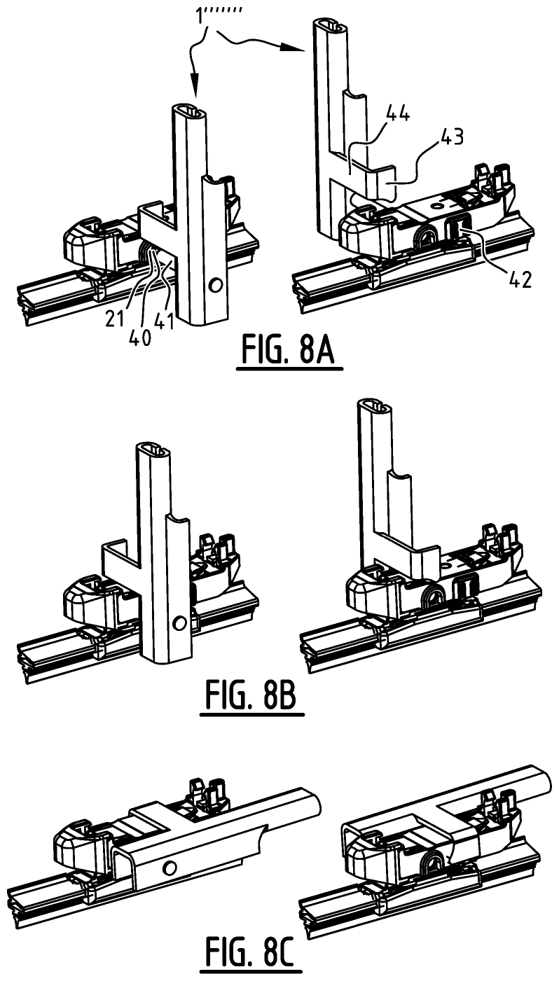

FIG. 8 shows several schematic and perspective views of part of a windscreen wiper device in a preferred embodiment, comprising a connecting device 2, a joint part 3 with an attached cover 31 and an oscillating arm of the seventh type 1″″″ in different stages of the assembly process. The cover 31, joint part 3 and connecting device 2 are provided with co-axial through holes 21,40, arranged for receiving a transverse pivot pin 41 provided near a free end of an oscillating arm of the seventh type 1′″″″. An outwardly extending protrusion 42, arranged on a longitudinal side of the cover 31, is arranged to abut a leg 43 of the L-shaped shoulder 44.

The invention is not restricted to the variants shown in the drawing, but it also extends to other embodiments that fall within the scope of the appended claims.

1. A windscreen wiper device of the flat blade type comprising an elastic, elongated carrier element and an elongated wiper blade of a flexible material, which can be placed in abutment with a windscreen to be wiped, said wiper blade including at least one longitudinal groove, in which groove a longitudinal strip of the carrier element is disposed, said windscreen wiper device comprises:
a connecting device, and
a joint part detachably and pivotally connected to said connecting device about a pivot axis, wherein said joint part includes at least one resilient tongue arranged to engage a correspondingly shaped hole provided in a base of a U-shaped cross-section of an oscillating arm of a first type or an oscillating arm of a second type,
wherein said at least one resilient tongue is hingeable between an inward position and an outward position,
wherein said at least one resilient tongue comprises a first step arranged to abut an edge of said hole of an oscillating arm of a first type facing towards a free end thereof and a second step arranged to abut an edge of said hole of an oscillating arm of a second type facing towards a free end thereof,
wherein said oscillating arm of the first type and said oscillating arm of the second type differ in a distance between legs of the U-shaped cross-section of said oscillating arms, and
wherein said joint part comprises at least one stepped profile having a first step arranged to restrict longitudinal movement of said oscillating arm of the first type in a direction towards a free end of said joint part and having-a second step arranged to restrict longitudinal movement of said oscillating arm of the second type in a direction towards said free end of said joint part.

2. A windscreen wiper device according to claim 1, wherein an upper surface of said first step of said stepped profile is located closer to said wiper blade than an upper surface of said second step of said stepped profile.

3. A windscreen wiper device according to claim 1, wherein a distance between the legs of the U-shaped cross-section of said oscillating arm of the first type is 22 mm, and wherein a distance between the legs of the U-shaped cross-section of said oscillating arm of the second type is 19 mm.

4. A windscreen wiper device according to claim 1, wherein said joint part comprises two stepped profiles on opposite lateral sides thereof.

5. A windscreen wiper device according to any of the preceding claims 1 through 4, wherein said joint part comprises at least one laterally outwardly extending resilient protrusion arranged to engage a leg of said U-shaped cross-section of said oscillating arm of the first type.

6. A windscreen wiper device according to claim 5, wherein said joint part comprises two laterally outwardly extending resilient protrusions on opposite lateral sides thereof.

7. A windscreen wiper device according to claim 1, wherein said first step of said stepped profile is arranged to abut against inwardly bent edges of legs of said U-shaped cross-section of said oscillating arm of the first type.

8. A windscreen wiper device according to claim 1, wherein said second step of said stepped profile is arranged to abut against legs of said U-shaped cross-section of said oscillating arm of the second type.

9. A windscreen wiper device according to claim 1, wherein said joint part is detachably connected to said connecting device by engaging protrusions of said connecting device, at the location of said pivot axis, in recesses provided in said joint part, wherein said protrusions of said connecting device are provided with co-axial through holes, wherein an upper surface of said joint part comprises a recess arranged to accommodate a L-shaped shoulder provided near said free end of an oscillating arm of a third type, wherein said co-axial through holes are arranged to receive a transverse pivot pin provided near said free end of said oscillating arm of the third type, and wherein a side of said joint part is arranged to abut a leg of said L-shaped shoulder disposed at an end thereof and facing a windscreen to be wiped.

10. A windscreen wiper device according to claim 9, wherein said joint part has an at least substantially U-shaped cross-section at a location of its connection to said connection device, wherein said joint part in each leg of said U-shaped cross-section is provided with said recess provided co-axially with said pivot axis, and wherein said co-axial recesses of said legs of said U-shaped cross-section and said co-axial through holes of said protrusions of said connecting device are arranged to receive said pivot pin of said oscillating arm of the third type.

11. A windscreen wiper device according to claim 1, wherein said joint part is provided with a free end having a recess arranged to accommodate a free end of an oscillating arm of a fourth type or an oscillating arm of a fifth type, wherein said joint part comprises at least one protrusion extending laterally from a longitudinal side of said joint part, said protrusion begin arranged to hook behind a correspondingly shaped protrusion on said oscillating arm of the fourth or said oscillating arm of the fifth type for restricting a longitudinal movement of said wiper blade with respect to said oscillating arm of the fourth or said oscillating arm of the fifth type.

12. A windscreen wiper device according to claim 11, wherein said joint part has an at least substantially U-shaped cross-section at the location of its connection to said connection device, and wherein a base of said U-shaped cross-section of said joint part comprises said recess arranged to accommodate said free end of said oscillating arm of the fourth or said oscillating arm of the fifth type.

13. A windscreen wiper device according to claim 12, wherein said free end of said joint part is resilient and can pivot about a hinge axis between a first position for mounting or dismounting said free end of said oscillating arm of the fourth or said oscillating arm of the fifth type into or from said recess in the base of the U-shaped cross-section of said joint part, and a second position for connecting said free end of said oscillating arm of the fourth or said oscillating arm of the fifth type to said joint part.

14. A windscreen wiper device according to claim 1, wherein a cover is detachably connected to said joint part.

15. A windscreen wiper device according to claim 14, wherein said cover is detachably connected to said joint part by engaging protrusions of said connecting device at the location of said pivot axis, in recesses provided in said cover.

16. A windscreen wiper device according to claim 14, wherein an upper surface of said cover comprises a recess arranged to accommodate a rod-shaped oscillating arm of a sixth type.

17. A windscreen wiper device according to claim 15, wherein said cover has an at least substantially U-shaped cross-section at a location of its connection to said joint part, and wherein said recess is provided in a base of the U-shaped cross-section.

18. A windscreen wiper device according to claim 16, wherein said cover comprises two spaced-apart guiding protrusions extending upwardly from an upper surface of said cover, and wherein said guiding protrusions are adapted to receive said oscillating arm of the sixth type between them.

19. A windscreen wiper device according to claim 16, wherein said cover is provided with a protrusion in use extending in upward direction away from a windscreen to be wiped, and wherein said upwardly extending protrusion is adapted to engage in a correspondingly shaped hole provided in said oscillating arm of the sixth type for retaining said wiper blade onto said oscillating arm of the sixth type.

20. A windscreen wiper device according to claim 14, wherein said cover has an at least substantially U-shaped cross section at the location of its connection to said joint part, and wherein said cover is provided with through holes in each leg of said U-shaped cross-section, which through holes are co-axially arranged with said pivot axis for receiving a transverse pivot pin provided near said free end of an oscillating arm of the seventh type.

21. A windscreen wiper device according to claim 20, wherein at least one outwardly extending protrusion, arranged on at least one side of a longitudinal side of the cover, is arranged to abut a leg of an L-shaped shoulder arranged near said free end of said oscillating arm of the seventh type.

22. A windscreen wiper device according to claim 11, wherein said protrusions extending laterally from the longitudinal side of said joint part are arranged on a resilient part of said longitudinal side, said resilient part is arranged to hinge inwardly and outwardly in a direction laterally from the longitudinal side about a hinge axis.

23. (canceled)
